(19) United States
(12) Patent Application Publication
(10) Pub. No.: US 2016/0032607 A1
(43) Pub. Date: Feb. 4, 2016

(54) IMPACT BARRIER SYSTEM

(71) Applicants: Kenneth R. RACH, Naperville, IL (US); Lee M. TAYLOR, Cedar Crest, NM (US)

(72) Inventors: Kenneth R. RACH, Naperville, IL (US); Lee M. TAYLOR, Cedar Crest, NM (US)

(73) Assignee: Structural Integrity Associates, San Jose, CA (US)

(21) Appl. No.: 14/813,926

(22) Filed: Jul. 30, 2015

Related U.S. Application Data
(60) Provisional application No. 62/030,892, filed on Jul. 30, 2014.

(51) Int. Cl. E04H 9/14; B32B 13/12

(52) U.S. Cl. CPC E04H 9/14; B32B 13/12; B32B 2307/558; B32B 2307/56; B32B 2305/34; B32B 2305/08; B32B 2571/00

(57) ABSTRACT

The present invention provides methods and systems for an impact barrier system that includes a concrete panel having a front side and a back side, and an ultra-high molecular weight polyethylene layer engaged to at least one side of the concrete panel.

### CROSS REFERENCE TO RELATED PATENT APPLICATION

The present non-provisional patent/patent application claims priority to U.S. Provisional Patent Ser. No. 62/030,892 filed Jul. 30, 2014 and entitled “AIR-BORN MISSILE IMPACT BARRIER,” the contents of which are incorporated by reference herein.

### FIELD OF THE INVENTION

The present invention relates generally to an impact barrier system and method thereof and more particularly relates to an impact barrier system consisting of concrete panels having ultra-high molecular weight polymer layers engaged thereto and a method for forming the system.

### BACKGROUND OF THE INVENTION

The Nuclear Regulatory Commission (NRC) published Regulatory Guide 1.76, Design-basis tornado and tornado missiles for nuclear power plants. Per Regulatory Guide 1.76, systems, structures and components which are important to the safety of nuclear power plants must be designed to withstand the natural phenomena, such as tornados, without loss of capability to perform their safety function. There are multiple tornado generated missiles which are identified and one of those hardest to protect against is the impact by an air-born 15 foot long steel pipe, which is 6 inch diameter and 0.28 inch wall thickness traveling at a speed of 92 mph. This systems meets the requirements of NRC Regulatory Guide to protect against the threat of large mass wind generated missiles. This system can also be used at any industrial, commercial or military facility requiring protection of people and important infrastructure such as power transformers, tanks containing volatile chemicals, offices complexes, equipment, electronic data centers, and emergency generators.

Currently the only way to protect these systems, structures, and components is to construct a very thick (>12″) reinforced concrete wall around them. When existing components are reclassified as being important to safety or new systems or components important to safety are added they must also be protected. Construction of a barrier system around these systems or components must be accomplished in a constricted space with minimal interference on the ongoing operations of the plant. The missile threat is difficult to alleviate with standard construction materials, as massive concrete walls (in excess of 12 in thick) or extremely thick steel panels (in excess of 2 in thick) would be required.

The present invention provides a relatively thin, impact barrier. The impact barrier may comprise a modular, tilt-up panel, which can be constructed on-site and installed within a constricted space. The impact barrier consists of a concrete panel having a layer of ultra-high molecular weight polyethylene (UHMwPE) engaged thereto along with a unique cabling and support system providing acceptable protection of the critical equipment subject to the threat. Due to its modular design each component of the overall system can be removed if access to the area is required or one of the components is damaged.

### BRIEF SUMMARY OF THE INVENTION

According to an embodiment of the present invention, an impact barrier system includes a concrete panel having a front side and a back side, and an ultra-high molecular weight polyethylene layer engaged to at least one side of the concrete panel.

According to yet another embodiment of the present invention, the impact barrier system includes a reinforced concrete panel.

According to yet another embodiment of the present invention, the impact barrier system includes an ultra-high molecular weight polyethylene layer engaged to front side and the back side of the concrete panel.

According to yet another embodiment of the present invention, the impact barrier system includes an ultra-high molecular weight polyethylene layer that substantially covers the front side of the concrete panel.

According to yet another embodiment of the present invention, the impact barrier system includes an ultra-high molecular weight polyethylene layer that substantially covers the back side of the concrete panel.

According to yet another embodiment of the present invention, the impact barrier system includes an ultra-high molecular weight polyethylene layer that contains between about 1 to about 200 plys.

According to yet another embodiment of the present invention, the impact barrier system includes an ultra-high molecular weight polyethylene layer that is about ¼″ thick.

According to yet another embodiment of the present invention, the impact barrier system includes at least two concrete panels having a first side and a second side, at least one steel column for selectively securing the first side of each concrete panel, and am ultra-high molecular weight polyethylene layer engaged to at least one side of the concrete panel.

According to yet another embodiment of the present invention, the impact barrier system includes at least two steel columns with a cable selectively secured to the first column and the second column and positioned adjacent the back side of the concrete panel.

According to yet another embodiment of the present invention, the impact barrier includes a concrete panel reinforced with steel rods.

According to yet another embodiment of the present invention, the impact barrier includes a steel column is an H-shaped steel column.

According to yet another embodiment of the present invention, a method for forming an impact barrier system that includes providing at least one concrete panel having at least two sides, at least one layer of ultra-high molecular weight polyethylene, and at least two steel columns. The ultra-high molecular weight polyethylene is engaged to at least one side of the concrete panel, and the at least two steel columns are secured in the vertical direction. The at least one concrete panel is selectively secured to the steel column.

According to yet another embodiment of the present invention, a method of forming the impact barrier system that includes providing an H-shaped reinforced concrete panel for receiving the first side of a concrete panel.

According to yet another embodiment of the present invention, a method of forming the impact barrier system that includes at least two layers of ultra-high molecular weight polyethylene and engaging the at least two layers to the front side and the back side of the concrete panel.

### BRIEF DESCRIPTION OF THE DRAWINGS

The present invention is illustrated and described herein with reference to the various drawings, in which like reference numbers denote like method steps and/or system components, respectively, and in which:

FIG. 1 is an exploded view of a panel of the present invention;

FIG. 2 is a top perspective view of one embodiment of the present invention;

FIG. 3 is a rear perspective view of another embodiment of the present invention;

FIG. 4 is a top perspective view of another embodiment of the present invention;

FIG. 5 is a front perspective view of another embodiment of the present invention; and

FIG. 6 is a front perspective view of another embodiment of the present invention

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

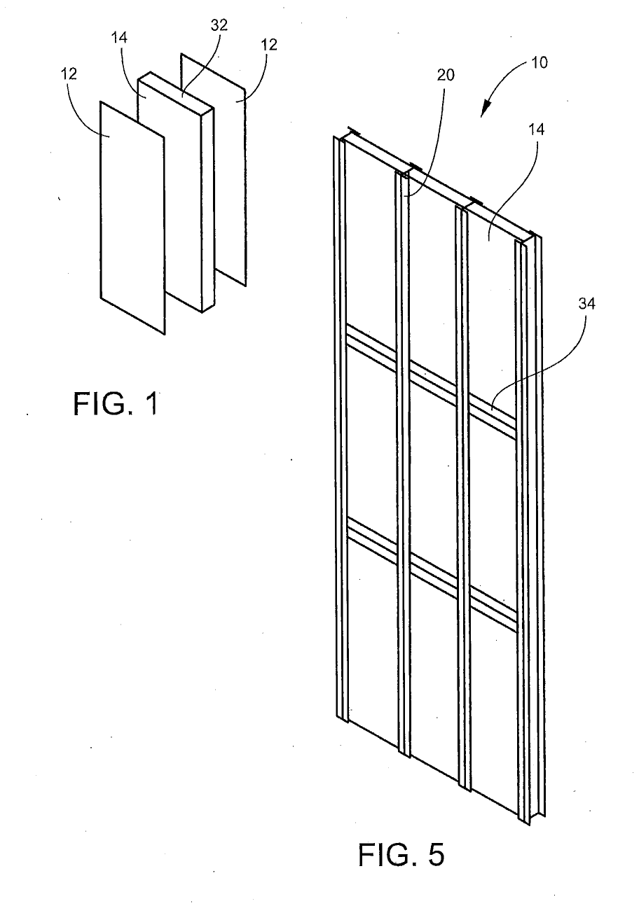

Referring now specifically to the drawings, an improved impact barrier system 10 is illustrated in FIG. 1 and is shown generally at reference numeral 10. The impact barrier includes a layer of ultra-high molecular weight polyethylene (UHMwPE) 12 engaged to a concrete panel 14. As illustrated in FIG. 1, the impact barrier system 10 may include a layer of UHMwPE 12 on either side of a concrete panel 14. In other words, the concrete panel 14 is sandwiched by the UHMwPE layers 12.

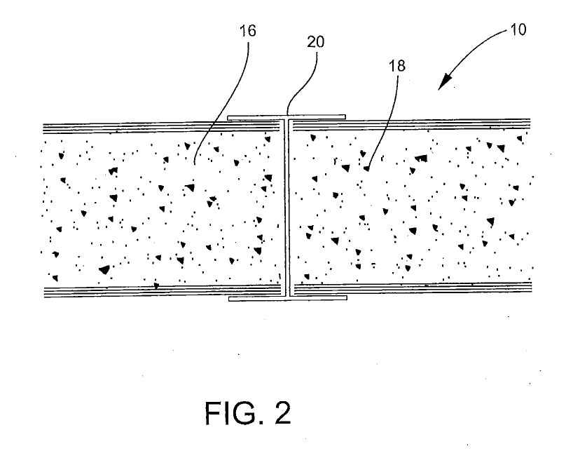

As illustrated in FIG. 2, one exemplary embodiment of the present invention includes a left panel 16 and right panel 18 that are engaged to each other by an H-shaped steel column 20. The panels (16,18) are supported in their vertical position by the H-shaped steel columns 20 with no connections except through contact/friction. Each panel (16,18) includes a front side and a back side. A layer of ultra-high molecular weight polyethylene (UHMwPE) 12 may be engaged to at least one side of the left panel 16 and right panel 18. As illustrated in FIG. 1, the layer of UHMwPE 12 is engaged to both the front side and the back side of the left panel 16 and right panel 18.

UHMwPE are also known as high-modulus polyethylene (HMPE) or high-performance polyethylene (HPPE). One such UHMwPE is sold under the trade name DYNEEMA and produced by Royal DSM of the Netherlands. The extremely long chains of polyethylene in an UHMwPE can effectively transfer the load to a polymer backbone by strengthening intermolecular interactions, thus providing enhanced impact strength.

The impact layer of the barrier system 10 of the present invention comprises panels, such as the left panel 16 and right panel 18 in FIG. 2, composed of concrete. The panel may be a reinforced concrete panel that may be engaged to adjacent concrete panels by H-shaped steel columns 20 and/or reinforcement members 30, such as cables. The concrete panels may be prefabricated in a controlled environment to be transported as required. In contrast, cast in situ concrete panels may be poured into a formwork structure on site. As shown in FIG. 2, the H-shaped steel columns 20 contain a continuous center portion and two open end portions adjacent the center portion. These open end portions receive an end of the concrete panel 14. As illustrated in FIG. 2, the steel column 20 is secured in the vertical direction on the ground or another surface, such as an asphalt or concrete surface. In one embodiment, the steel columns 20 are engaged to a concrete footer or the like, for stabilizing the steel column 20 in the vertical direction.

The concrete panels 14 are lifted vertically and above the steel column 20. An end of each concrete panel 14 is inserted into the open end portions of the steel columns 20, forming a selectively secured arrangement. Once inserted into the open end of the steel columns 20, the concrete panel 14 is slid along the length of the open end portion of the steel column 20. The process takes place and is completed for each concrete panel 14 contained within the system 10.

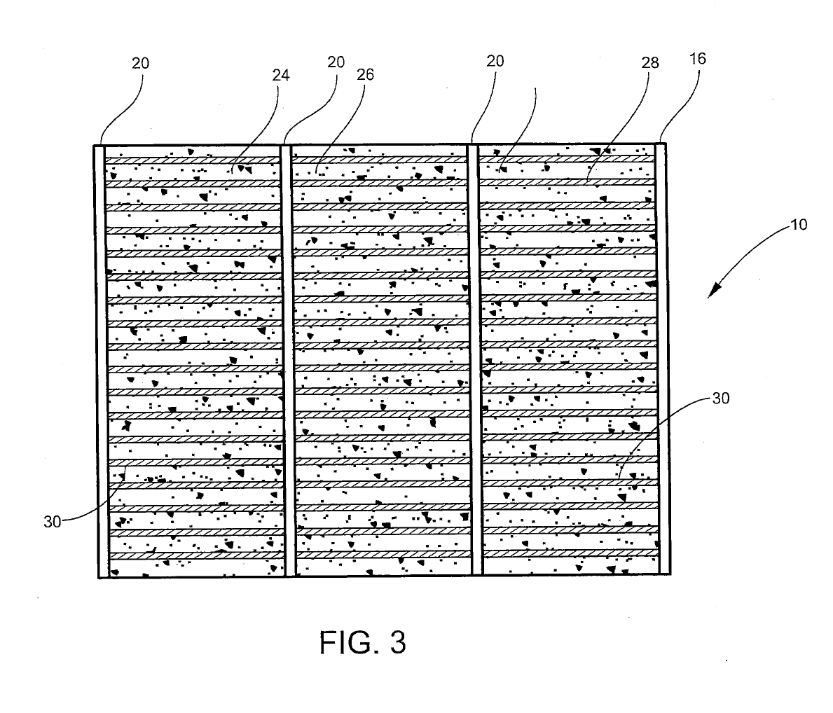

FIG. 3 illustrates another exemplary impact barrier system 10 that includes a first panel 24, a second panel 26, and a third panel 28. The panels (24,26,28) are engaged to each other and supported by H-shaped columns 20 disposed on both the first side and second side of each panel (24,26,28). Each panel (24,26,28) includes reinforcement members 30. As illustrated, the reinforcement members 30 are lateral reinforcement members, such as lateral steel cabling. The UHMwPE layer 12 may be contained on one side of each panel (24,26,28) or on both the front side and the back side of each panel (24,26,28).

The reinforcement members 30, as illustrated in FIG. 3, connect the H-shaped columns 20 with the reinforcement members 30 in a spaced-apart arrangement. Preferably, the reinforcement members 30 are spaced between about 12 inches to about 24 inches apart and are disposed along the same plane adjacent the back side of each panel for providing support and confinement during impact. In this embodiment, the cables are not physically attached to the concrete panel, but contact the back side of the concrete panel.

In another alternative embodiment of the invention, the system 10 may comprise a concrete panel 14 that includes reinforcement members 30 extending through and potentially protruding from the concrete panel 14. The reinforcement members 30 may be uniformly distributed and are typically steel rods, such as rebar, fabricated to carry tensile loads. The concrete panel 14 may also be prestressed for additional strength characteristics using both pre- and post-tensioning methods. The concrete panels 14 may be any size as required by the user. Specifically, the concrete panels 14 may be between about 0.5 ft. to about 40 ft. wide, and preferably between about 2 ft. to about 20 ft. wide. The concrete panels 14 may be erected in a series of panels interconnected by the H-shaped steel columns. For example, to provide an impact barrier for a transformer field, between about 25 to about 40 concrete panels 14 may be arranged in series to protect the transformer field.

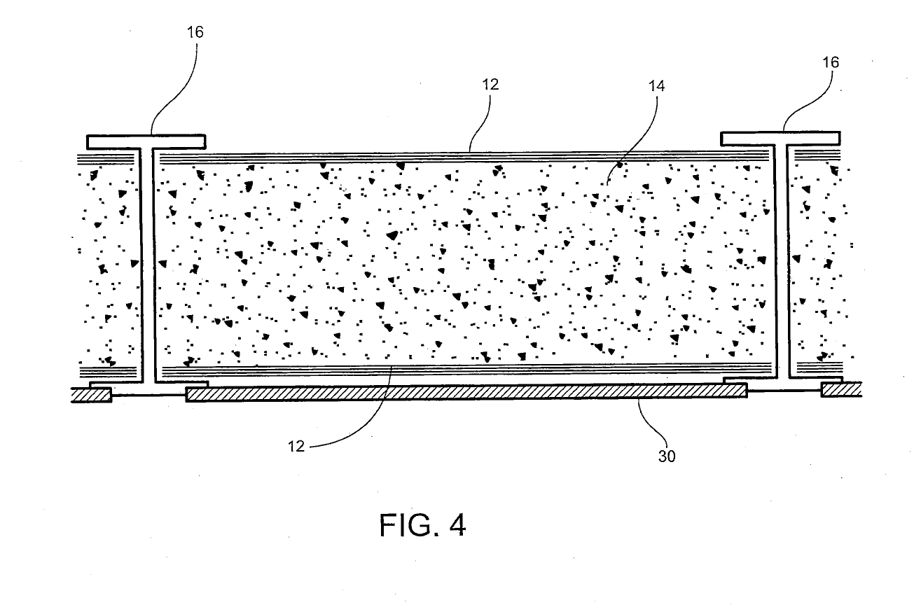

The UHMwPE layer 12 may be in many alternative forms. As illustrated in FIGS. 1-4, the UHMwPE layer 12 is a continuous sheet that is engaged to the side of the concrete panel 14. Each UHMwPE layer 12 may contain between about 1 to about 200 plys, and more preferably, each UHMwPE layer 12 may contain between about 3 to about 100 plys. Each ply is heat treated to bond the plys together forming a single, sheet of varying thickness, depending upon the number of plys bonded together. For example, 100 plys bonded together produces an approximately ¼″ thick layer.

As illustrated, the UHMwPE layer 12 is a continuous layer that substantially covers the entire surface area of the front side and back side of the concrete panel 14. It should also be understood that the UHMwPE layer 12 may consist of a noncontinous layer. For example, the UHMwPE layer 12 may consist of strips of UHMwPE arranged in either the horizontal direction, vertical direction, or both directions on the concrete panel 14.

As illustrated in FIG. 5, the concrete panels 14 may be stacked upon each other. The steel columns 20 extend the along the height of the concrete panels 14 and a securing device 34 may be located between the top portion of a concrete panel 14 and the bottom portion of the adjacent concrete panel 14.

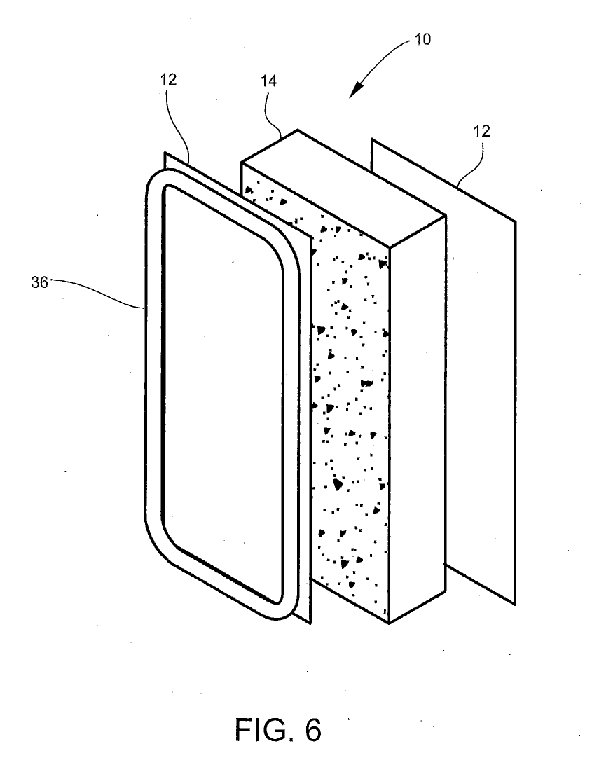

An alternative embodiment, as shown in FIG. 6, includes a spacer 36 adjacent the front side of the concrete panel 14 having a UHMwPE layer 12 engaged thereto. The spacer 36 is located adjacent the UHMwPE layer 12 as shown in FIG. 6. The edges of the spacer 36 are contained within the open end of the steel column 20 of the impact system 10. Upon impact by an object on the front side of the system 10, the structural transition point to be on the system 10 will be on the steel column 20 and not the spacer 36. The spacer 36 prevents the concrete panel 14 from having excessive movement within the steel column 20.

The overall design of the air-borne impact barrier system 10 is to create a modular system. The concrete panel 14 may also include an embedded anchor. The anchor 32 allows the concrete panel 14 to be lifted and moved by a crane or like device. The impact barrier system 10 has been shown analytically to meet the requirements of NRC Regulatory Guide 1.76 to be able to stop high mass components at tornado generated wind speeds.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An impact barrier system, comprising:
a concrete panel having a front side and a back side; and
a ultra-high molecular weight polyethylene layer engaged to at least one side of the concrete panel.

2. The impact barrier system of claim 1, further comprising a reinforced concrete panel.

3. The impact barrier system of claim 1, further comprising the ultra-high molecular weight polyethylene layer is engaged to front side and the back side of the concrete panel.

4. The impact barrier system of claim 1, wherein the ultra-high molecular weight polyethylene layer substantially covers the front side of the concrete panel.

5. The impact barrier system of claim 1, wherein the ultra-high molecular weight polyethylene layer contains between about 1 to about 200 plys.

6. The impact barrier system of claim 1, wherein the ultra-high molecular weight polyethylene forms a layer of about ¼″ thick.

7. An impact barrier system, comprising:
at least two concrete panels having a first side and a second side;
at least one steel column for selectively securing the first side of each concrete panel; and
a ultra-high molecular weight polyethylene layer engaged to at least one side of the concrete panel.

8. The impact barrier system of claim 7, further comprising reinforced concrete panels.

9. The impact barrier system of claim 7, further comprising the ultra-high molecular weight polyethylene layer is engaged to front side and the back side of the concrete panel.

10. The impact barrier system of claim 7, wherein the ultra-high molecular weight polyethylene layer substantially covers the front side of the concrete panel.

11. The impact barrier system of claim 7, wherein the ultra-high molecular weight polyethylene layer contains between about 1 to about 200 plys.

12. The impact barrier system of claim 7, wherein the ultra-high molecular weight polyethylene forms a layer of about ¼″ thick.

13. The impact barrier system of claim 7, further comprising at least two steel columns with a reinforcement member selectively secured to the first column and the second column and positioned adjacent the back side of the concrete panel.

14. The impact barrier system of claim 1, wherein the concrete panel is reinforced with steel rods.

15. The impact barrier system of claim 1, wherein the steel column is an H-shaped steel column.

16. A method for forming an impact barrier, comprising:
providing at least one concrete panel having at least two sides, at least one layer of ultra-high molecular weight polyethylene, and at least two steel columns;
engaging the ultra-high molecular weight polyethylene to at least one side of the concrete panel;
securing the at least two steel columns in the vertical direction; and
selectively securing the at least one concrete panel to the steel column.

17. The method of forming an impact barrier of claim 1, further comprising providing an H-shaped reinforced concrete panel for receiving a first side of a concrete panel.

18. The method of forming an impact barrier of claim 1, further comprising at least two layers of ultra-high molecular weight polyethylene and engaging the at least two layers to the front side and the back side of the concrete panel.
